(19) United States
(12) Patent Application Publication
(10) Pub. No.: US 2006/0086565 A1
(43) Pub. Date: Apr. 27, 2006

(54) Raisable work bench

(76) Inventors: Michael Hernandez, Bakersfield, CA (US); Carlos Torres, Bakersfield, CA (US)

Correspondence Address: James M. Duncan;c/o Klein, DeNatale, Goldner, Cooper,, Rosenlieb & Kimball, P.O. Box 11172, Bakersfield, CA, 93389-1172, US

(21) Appl. No.: 11/143,974

(22) Filed: May 31, 2005

Related U.S. Application Data
(60) Provisional application No. 60/576,423, filed on Jun. 1, 2004.

(51) Int. Cl. E06C 1/38

(52) U.S. Cl. 182/1

(57) ABSTRACT

A raisable work bench may be used to raise or lower the work surface as required for access, storage or other purposes. The work bench comprises a base, a draw works, a stationary frame, a sliding frame, and a work platform which cantilevers from the sliding frame. The work platform may be pivotally attached at one end to the sliding frame. The device may optionally have a second shelf pivotally attached to the sliding frame. Support arms may extend from the sliding frame to the underside of the work platform. Flexible connectors such as straps, cables, or rope are connected from the draw works to the sliding frame.

### CROSS-REFERENCE TO RELATED APPLICATION

U.S. Provisional Application No. 60/576423 for this invention was filed on Jun. 1, 2004 for which the inventor claims domestic priority.

### BACKGROUND OF THE INVENTION

The present invention generally relates to work benches and adjustable shelving units. 10 The present invention is more specifically a workbench and shelf unit which is mountable on the framework of a garage or other structure, which is available when required, but which may be raised or lowered as necessary to allow for access, such as when a car is parked inside a garage. The present invention also comprises a method of using the disclosed apparatus.

It is known to utilize foldable workbenches so that the work surface may be available when required for various purposes, and then to fold the work surface up from a horizontal orientation to a vertical orientation, allowing a more efficient use of space. However, such devices typically require the user to remove all objects from the work surface in order to get the work surface out of the way. For example, if the device is stored against an interior wall of the garage, the user may have to remove all items from the work surface and fold up the work surface in order to park a car in the garage. The present device allows the work surface, while remaining in a horizontal orientation, to be raised or lowered by a prime mover, such that the work surface is raised or lowered and out of the way. The work surface of the present device is also capable of pivoting from a horizontal orientation to a vertical orientation as required.

### SUMMARY OF THE INVENTION

The present invention is directed to a device and apparatus which provides a solution to the problems identified above. The present apparatus comprises a base, a draw works, a stationary frame, a sliding frame, and a work platform cantilevered from the sliding frame. The work platform may be pivotally attached at one end to the sliding frame. The device may optionally have a second shelf pivotally attached to the sliding frame. Support arms may extend from the sliding frame to the underside of the work platform. Flexible connectors such as straps, cables, or rope are connected from the draw works to the sliding frame.

### BRIEF DESCRIPTION OF THE DRAWINGS

FIG. 1 shows a perspective view of the disclosed raisable work bench, with the work platform in a raised position.

FIG. 2 shows how the work platform may be folded into a vertical orientation, and how the optional secondary shelf may also be folded into a vertical orientation.

FIG. 3 shows the work platform in a lowered position.

FIG. 4 shows how the wheel assemblies of the sliding frame engage the stationary frame.

### DETAILED DESCRIPTION OF THE EMBODIMENTS

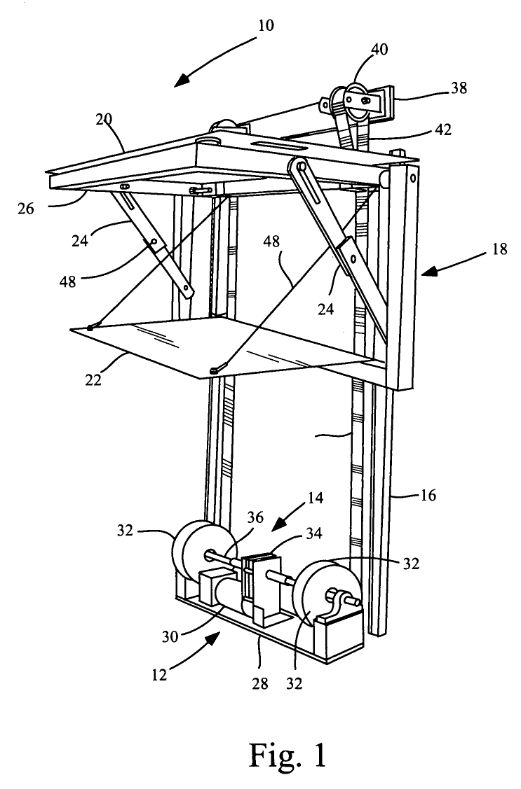

Referring now specifically to the drawings, FIG. 1 shows a perspective view of the disclosed raisable work bench 10. The apparatus generally comprises a base 12, a draw works 14, a stationary frame 16, a sliding frame 18, and a work platform 20 cantilevered from the sliding frame. The work platform 20 may be pivotally attached at one end to the sliding frame 18. The device may optionally have a second shelf 22 pivotally attached to the sliding frame. Support arms 24 may extend from the sliding frame 18 to the underside 26 of the work platform 20.

Base 12 comprises a ground engaging member 28 for support of the apparatus. The base 12 further comprises framework for the mounting of the lower portion of the draw works 14. Draw works 14 comprises a prime mover 30, which is operably coupled to drive sheaves 32 by gear reducer 34 and drive shaft 36. Prime mover 30 may be a reversible electric motor powered either by rechargeable battery or by an alternating current source. An acceptable motor is a Power Gear model number 13-1109.

The upper draw works further comprises an upper portion which comprises upper member 38, to which are attached pulleys 40. Flexible connectors 42, such as straps, cables, or rope are connected on a first end to a drive sheave 32, and looped over pulley 40. The second end of each flexible connector 42 is attached to sliding frame 18. Sliding frame 18 is formed of four members forming a rectangular frame. Wheel assemblies 44 are attached to the vertical members of sliding frame 18, where the wheels of the wheel assemblies 44 are engaged within channels 46 of the vertical members of the stationary frame 16. Work platform 20 may be pivotally attached to sliding frame 18. When work platform 20 is in a horizontal orientation, it cantilevers outward from sliding frame 18. Work platform 20 may be bounded by a retaining lip which extends around the working surface. The retaining lip would extend above the working surface and retain items on the working surface as the work platform 20 is lowered or raised. In addition, the working surface may comprise other features desired by a craftsman, such as mounting holes for a vise, radial saw or other devices. The working surface may also comprise gauging features, such as a measuring rule or tee square.

Support arms 24 may be utilized to provide support for work platform 20. Support arms 24 may have a pivot joint 48 and slot 50 which allow the support arms to be folded or collapsed as the work platform 20 is folded into a vertical position. Prime mover 30, operating through gear reducer 34 rotates drive shaft 36, thereby rotating drive sheaves 32. Flexible connectors 42 may be wrapped onto drive sheaves 32, causing sliding frame 18 to be elevated with respect to stationary frame 16. Conversely, if the direction of the prime mover 30 is reversed, flexible connectors 42 are unwound from drive sheaves 32, causing sliding frame 18 to be lowered with respect to stationary frame 16.

Second shelf 22, which is optional, may be pivotally attached to sliding frame 18. Second shelf 22 may be supported by cables 48. Second shelf 22 may be folded into a vertical position. Second shelf 22 may be held in the vertical position by folding work platform 20 into a vertical position after positioning second shelf 22 into the vertical position.

Stationary frame 16 is attached with fastening means to support structures of a wall. For example, if the device is to be used in a garage, stationary frame 16 would be bolted to the wall studs or other frame members. Upper member 38 would likewise be fastened to similar structural members.

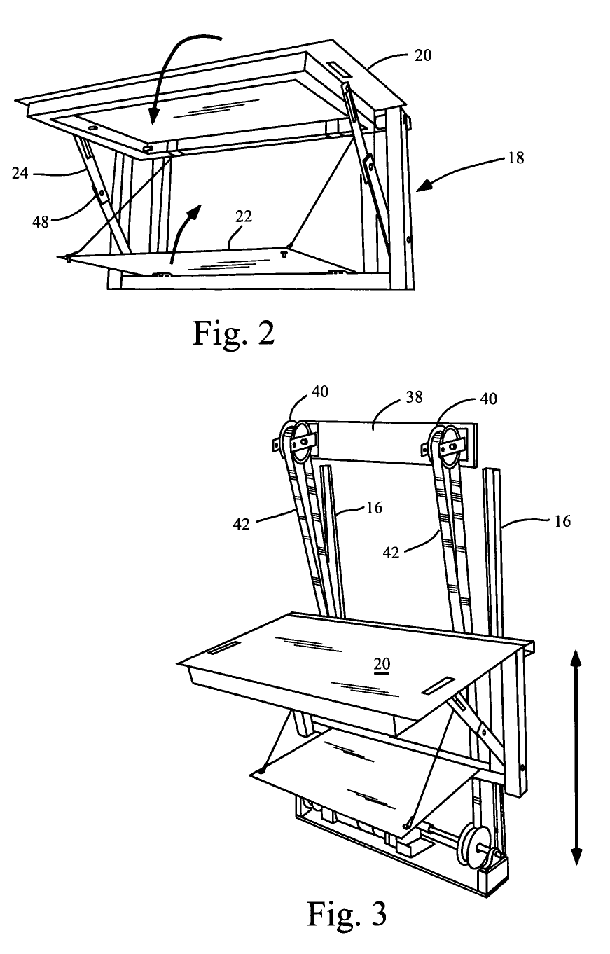

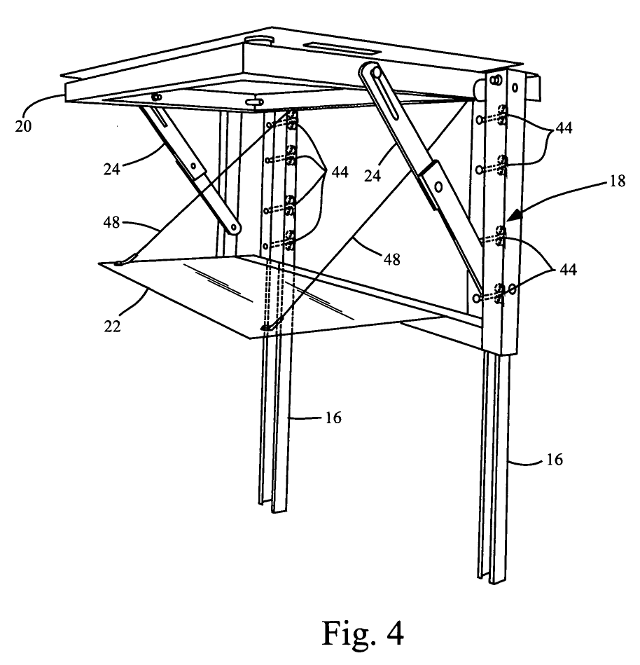

Use of the disclosed device is relatively simple. The user may employ the work platform 20 as desired for carpentry, mechanical work, etc. When necessary to get the work platform 20 out of the way, the user activates prime mover 30, causing the work platform to either be raised or lowered, while remaining in a horizontal orientation. The height which the work platform may be raised depends, of course, upon the length of the stationary frame 16. Typically, stationary frame 16 will be sufficiently long to allow work platform 20 to be raised high enough to pull an automobile underneath the work platform. Positive locking devices may be employed to lock sliding frame 18 to stationary frame 16 to prevent any sudden release of work platform 20. FIG. 1 shows the device 10 with the sliding frame in a raised position. The arrows of FIG. 2 shows how second shelf 22 may be pivoted upward into a vertical position, and work platform 20 thereafter pivoted downwardly into a vertical position, locking second shelf 22 into a vertical position.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. A work bench comprising:
a ground engaging base;
a stationary frame extending upwardly from the ground engaging base;
a sliding frame connected to the stationary frame with sliding means;
a lower draw works disposed on the ground engaging base, the lower draw works comprising a prime mover and a drive sheave coupled to the prime mover;
an upper member disposed above the stationary frame;
a pulley attached to the upper member;
a flexible connector having a first end and a second end, the first end attached to the drive sheave and the second end attached to the sliding frame, wherein the strap loops around the pulley; and
a work platform attached to the sliding frame.

2. The work bench of claim 1 wherein the work platform is pivotally attached to the sliding frame, wherein the work platform may pivot from a first position to a second position, wherein in the first position the work platform is substantially vertical and abutting the sliding frame and in the second position the work platform cantilevers outwardly from the sliding frame in a substantially horizontal orientation.

3. The work bench of claim 2 wherein the work platform is supported in the second position by a support arm, wherein the support arm folds as the work platform is folded into the first position.

4. The work bench of claim 1 wherein the prime mover is a reversible electric motor.

5. The work bench of claim 1 wherein the flexible connector is a strap.

6. The work bench of claim 1 wherein a gear reducer is disposed between the prime mover and the drive sheave.

7. The work bench of claim 1 wherein the sliding means comprises wheels connected to the sliding frame, wherein the wheels engage the stationary frame.

8. The work bench of claim 1 further comprising a second shelf attached to the sliding frame.

9. The work bench of claim 8 wherein the second shelf is pivotally attached to the sliding frame.

10. The work bench of claim 9 wherein the second shelf may pivot from a first position to a second position, wherein in the first position the second shelf is substantially vertical and abutting the sliding frame and in the second position the second shelf cantilevers outwardly from the sliding frame in a substantially horizontal orientation.

11. The work bench of claim 10 wherein the second shelf is supported in the second position by a cable attached between the sliding frame and the second shelf.

12. A work bench comprising:
a ground engaging base;
a stationary frame extending upwardly from the ground engaging base;
a sliding frame connected to the stationary frame with sliding means;
a lower draw works disposed on the ground engaging base, the lower draw works comprising a prime mover, a gear reducer and a first drive sheave and a second drive sheave respectively coupled to the gear reducer;
an upper member disposed above the stationary frame;
a first pulley and a second pulley attached to the upper member;
a first flexible connector and a second flexible connector, each respectively having a first end and a second end, the first end of the first flexible connector is attached to the first drive sheave and the second end of the first flexible connector is attached to the sliding frame, wherein the first flexible connector loops around the first pulley, and the first end of the second flexible connector is attached to the second drive sheave and the second end of the second flexible connector is attached to the sliding frame, wherein the second flexible connector loops around the second pulley; and
a work platform pivotally attached to the sliding frame, wherein the work platform may pivot from a first position to a second position, wherein in the first position the work platform is substantially vertical and abutting the sliding frame and in the second position the work platform cantilevers outwardly from the sliding frame in a substantially horizontal orientation.

13. The work bench of claim 12 further comprising a support arm which supports the work platform in the second position, wherein the support arm folds as the work platform is folded into the first position.

14. The work bench of claim 12 wherein the prime mover is a reversible electric motor.

15. The work bench of claim 14 wherein the first flexible connector and the second flexible connector are each straps.

16. The work bench of claim 12 wherein the sliding means comprises wheels connected to the sliding frame, wherein the wheels engage the stationary frame.

17. The work bench of claim 12 further comprising a second shelf attached to the sliding frame.

18. The work bench of claim 16 wherein the second shelf is pivotally attached to the sliding frame.

19. The work bench of claim 17 wherein the second shelf may pivot from a first position to a second position, wherein in the first position the second shelf is substantially vertical and abutting the sliding frame and in the second position the second shelf cantilevers outwardly from the sliding frame in a substantially horizontal orientation, wherein the second shelf is supported in the second position by a cable attached between the sliding frame and the second shelf.

20. A work bench comprising:
a ground engaging base;
a stationary frame extending upwardly from the ground engaging base;
a sliding frame connected to the stationary frame with wheels connected to the sliding 10 frame, wherein the wheels engage channels within the stationary frame;
a lower draw works disposed on the ground engaging base, the lower draw works comprising a reversible electric motor, a gear reducer and a first drive sheave and a second drive sheave respectively coupled to the gear reducer;
an upper member disposed above the stationary frame;
a first pulley and a second pulley attached to the upper member;
a first strap and a second strap, each respectively having a first end and a second end, the first end of the first strap attached to the first drive sheave and the second end of the first strap attached to the sliding frame, wherein the first strap loops around the first pulley, and the first end of the second strap attached to the second drive sheave and the second end of the second strap attached to the sliding frame, wherein the second strap loops around the second pulley;
a work platform pivotally attached to the sliding frame, wherein the work platform may pivot from a first position to a second position, wherein in the first position the work platform is substantially vertical and abutting the sliding frame and in the second position the work platform cantilevers outwardly from the sliding frame in a substantially horizontal orientation;
a support arm which supports the work platform in the second position, wherein the support arm folds as the work platform is folded into the first position; and
a second shelf pivotally attached to the sliding frame wherein the second shelf may pivot from a first position to a second position, wherein in the first position the second shelf is substantially vertical and abutting the sliding frame and in the second position the second shelf cantilevers outwardly from the sliding frame in a substantially horizontal orientation, wherein the second shelf is supported in the second position by a cable attached between the sliding frame and the second shelf.
